(19) United States
(12) Patent Application Publication
(10) Pub. No.: US 2026/0116532 A1
(43) Pub. Date: Apr. 30, 2026

(54) Nose Landing Gear Assembly Steering Feedback System

(71) Applicant: GOODRICH CORPORATION, Charlotte, NC (US)

(72) Inventors: Dayananda Alagatta CHENNABASAVAIAH, Bangalore (IN); Akash Dwarakanath RAO, Bangalore (IN)

(73) Assignee: GOODRICH CORPORATION, Charlotte, NC (US)

(21) Appl. No.: 19/189,009

(22) Filed: Apr. 24, 2025

(30) Foreign Application Priority Data
Jun. 24, 2024 (IN) 202441048416

(51) Int. Cl. B64C 25/50; B64D 45/00

(52) U.S. Cl. CPC B64C 25/50; B64D 45/0005

(57) ABSTRACT

A nose landing gear assembly steering feedback system is disclosed herein. The nose landing gear assembly steering feedback system includes a static sensor, a rotating sensor, and a nose wheel steering control unit. The static sensor and the rotating sensor communicatively coupled to the nose wheel steering control unit. The nose wheel steering control unit is configured to: responsive to receiving a first input signal from the static sensor and a second input signal from the rotating sensor, determine at least one of a relative angular position, a steering direction, or a towing angle; and provide an indication of at least one of the relative angular position, the steering direction, or the towing angle to at least one of a pilot, air traffic control, or a ground crew.

### CROSS-REFERENCE TO RELATED APPLICATIONS

This application claims priority to, and the benefit of, India Provisional Patent Application No. 202441048416, filed Jun. 24, 2024 (DAS Code 9B0E) and titled “NOSE LANDING GEAR ASSEMBLY STEERING FEEDBACK SYSTEM,” which is incorporated by reference herein in its entirety for all purposes.

### FIELD

The present disclosure generally relates to the field of aircraft landing gear and, more particularly, to a nose landing gear assembly steering feedback system.

### BACKGROUND

Existing mechanical linkage feedback systems for aircraft nose-wheel landing gears typically involve multiple parts which raise the cost of the systems and face issues due to multiple stack paths of clearance. Additionally, other electro-mechanical nose-wheel landing gear feedback systems face issue with backlash/gear trains and calibration issues.

Certain aircrafts may be equipped with a nose-wheel landing gear steering mechanical lock or over travel mechanism, depending on the type of nose-wheel steering system, that avoids damage to the shock strut internals if the nose-wheel landing gear over travels beyond a specific or predefined nose-wheel landing gear orientation. However, unlocking a locked nose-wheel landing gear steering mechanism consumes considerable time as well as complete investigation and/or airworthiness approval of the nose-wheel landing gear. Moreover, on aircrafts equipped with steering/towing angle orientation markings on the nose-wheel landing gear, the steering/towing angle orientation markings may be overlooked by ground support personnel due to severe weather conditions, i.e. rain, fog, etc., or multiple tasks at hand which may lead to a nose-wheel landing gear over travel incident.

### SUMMARY

A nose landing gear assembly steering feedback system is disclosed herein. The nose landing gear assembly steering feedback system includes a static indicator, a rotating sensor, and a nose wheel steering control unit. The static indicator and the rotating sensor are communicatively coupled to the nose wheel steering control unit. The nose wheel steering control unit is configured to, responsive to receiving a first input signal from the static indicator and a second input signal from the rotating sensor, determine at least one of a relative angular position, a steering direction, or a towing angle, and provide an indication of at least one of the relative angular position, the steering direction, or the towing angle to at least one of a pilot, air traffic control, or a ground crew.

In various embodiments, the static indicator is at least one of aircraft orientation data received from a flight control system or a static sensor.

In various embodiments, the static sensor is mechanically coupled to a nose shock strut assembly of a nose landing gear assembly. In various embodiments, the static sensor is at least one of a tilt sensor, a yaw-measuring electronic compass (E-Compass) feedback sensor, or a yaw measuring high-accuracy micro electro-mechanical system (MEMS)-based inertial navigation systems (INS) sensors operating via a global navigation satellite system (GNSS). In various embodiments, the static sensor is aligned with an axis of rotation of at least one of a strut cylinder or main fitting of the nose landing gear assembly.

In various embodiments, the rotating sensor is mechanically coupled to at least one of a strut piston or a wheel axle of a nose landing gear assembly. In various embodiments, the rotating sensor is at least one of a tilt sensor, a yaw-measuring electronic compass (E-Compass) feedback sensor, or a yaw measuring high-accuracy micro electro-mechanical system (MEMS)-based inertial navigation systems (INS) sensors operating via a global navigation satellite system (GNSS).

In various embodiments, the rotating sensor is aligned with an axis of rotation of a strut piston of the nose landing gear assembly and an axis of rotation of a wheel of the nose landing gear assembly.

In various embodiments, the nose wheel steering control unit is further configured to provide the indication of at least one of the relative angular position, the steering direction, or the towing angle to a flight control system of an aircraft. In various embodiments, responsive to the at least one of the relative angular position, the steering direction, or the towing angle being different than a commanded relative angular position, a commanded steering direction, or a commanded towing angle, the nose wheel steering control unit is further configured to cause a corrective action to correct at least one of the relative angular position, the steering direction, or the towing angle to match at least one of the commanded relative angular position, the commanded steering direction, or the commanded towing angle.

In various embodiments, the indication of at least one of the relative angular position, the steering direction, or the towing angle to at least one of the pilot, the air traffic control, or the ground crew is displayed on a display of at least one of the pilot, the air traffic control, or the ground crew.

In various embodiments, the indication of at least one of the relative angular position, the steering direction, or the towing angle to at least one of the pilot, the air traffic control, or the ground crew is an alert, wherein the alert is at least one of an audio alert or a visual alert.

In various embodiments, the nose wheel steering control unit is further configured with predefined orientation angle limits for a nose landing gear assembly and wherein the nose wheel steering control unit is further configured to, responsive to at least one of the relative angular position, the steering direction, or the towing angle meeting one predefined orientation angle limit of the predefined orientation angle limits, provide at least one of a corrective feedback, an alert, or a corrective command to at least one of the pilot, the air traffic control, or the ground crew indicating that the one predefined orientation angle limit has been met.

In various embodiments, the nose wheel steering control unit is further configured with approaching predefined orientation angle limits for the nose landing gear assembly and wherein the nose wheel steering control unit is further configured to, responsive to at least one of the relative angular position, the steering direction, or the towing angle being between one predefined orientation angle limit of the predefined orientation angle limits and one approaching predefined orientation angle limit of the approaching predefined orientation angle limits, provide at least one of the corrective feedback, the alert, or the corrective command to at least one of the pilot, the air traffic control, or the ground crew.

Also disclosed herein is an aircraft. The aircraft includes a nose landing gear assembly steering feedback system. The nose landing gear assembly steering feedback system includes a static indicator, a rotating sensor, and a nose wheel steering control unit. The static indicator and the rotating sensor are communicatively coupled to the nose wheel steering control unit. The nose wheel steering control unit is configured to, responsive to receiving a first input signal from the static indicator and a second input signal from the rotating sensor, determine at least one of a relative angular position, a steering direction, or a towing angle, and provide an indication of at least one of the relative angular position, the steering direction, or the towing angle to at least one of a pilot, air traffic control, or a ground crew.

In various embodiments, the static indicator is at least one of aircraft orientation data received from a flight control system or a static sensor.

In various embodiments, the static sensor is mechanically coupled to a nose shock strut assembly of a nose landing gear assembly. In various embodiments, the static sensor is at least one of a tilt sensor, a yaw-measuring electronic compass (E-Compass) feedback sensor, or a yaw measuring high-accuracy micro electro-mechanical system (MEMS)-based inertial navigation systems (INS) sensors operating via a global navigation satellite system (GNSS). In various embodiments, the static sensor is aligned with an axis of rotation of at least one of a strut cylinder or main fitting of the nose landing gear assembly.

In various embodiments, the rotating sensor is mechanically coupled to at least one of a strut piston or a wheel axle of a nose landing gear assembly. In various embodiments, the rotating sensor is at least one of a tilt sensor, a yaw-measuring electronic compass (E-Compass) feedback sensor, or a yaw measuring high-accuracy micro electro-mechanical system (MEMS)-based inertial navigation systems (INS) sensors operating via a global navigation satellite system (GNSS).

In various embodiments, the rotating sensor is aligned with an axis of rotation of a strut piston of the nose landing gear assembly and an axis of rotation of a wheel of the nose landing gear assembly.

In various embodiments, the nose wheel steering control unit is further configured to provide the indication of at least one of the relative angular position, the steering direction, or the towing angle to a flight control system of an aircraft. In various embodiments, responsive to the at least one of the relative angular position, the steering direction, or the towing angle being different than a commanded relative angular position, a commanded steering direction, or a commanded towing angle, the nose wheel steering control unit is further configured to cause a corrective action to correct at least one of the relative angular position, the steering direction, or the towing angle to match at least one of the commanded relative angular position, the commanded steering direction, or the commanded towing angle.

In various embodiments, the indication of at least one of the relative angular position, the steering direction, or the towing angle to at least one of the pilot, the air traffic control, or the ground crew is displayed on a display of at least one of the pilot, the air traffic control, or the ground crew.

In various embodiments, the indication of at least one of the relative angular position, the steering direction, or the towing angle to at least one of the pilot, the air traffic control, or the ground crew is an alert, wherein the alert is at least one of an audio alert or a visual alert.

In various embodiments, the nose wheel steering control unit is further configured with predefined orientation angle limits for a nose landing gear assembly and wherein the nose wheel steering control unit is further configured to, responsive to at least one of the relative angular position, the steering direction, or the towing angle meeting one predefined orientation angle limit of the predefined orientation angle limits, provide at least one of a corrective feedback, an alert, or a corrective command to at least one of the pilot, the air traffic control, or the ground crew indicating that the one predefined orientation angle limit has been met.

In various embodiments, the nose wheel steering control unit is further configured with approaching predefined orientation angle limits for the nose landing gear assembly and wherein the nose wheel steering control unit is further configured to, responsive to at least one of the relative angular position, the steering direction, or the towing angle being between one predefined orientation angle limit of the predefined orientation angle limits and one approaching predefined orientation angle limit of the approaching predefined orientation angle limits, provide at least one of the corrective feedback, the alert, or the corrective command to at least one of the pilot, the air traffic control, or the ground crew.

The foregoing features and elements may be combined in any combination, without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates an aircraft, in accordance with various embodiments.

FIG. 2 illustrates nose landing gear assembly, in accordance with various embodiments.

FIG. 3 illustrates nose landing gear assembly steering feedback system integrated in an aircraft, in accordance with various embodiments.

FIG. 4 illustrates predefined orientation angle limits for a nose landing gear assembly, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values and all ranges and ratio limits disclosed herein may be combined.

As described previously, existing mechanical linkage feedback systems for aircraft nose-wheel landing gears typically involve multiple parts which raise the cost of the systems and face issues due to multiple stack paths of clearance. Additionally, other electro-mechanical nose-wheel landing gear feedback systems face issue with backlash/gear trains and calibration issues. Aircrafts equipped with a nose-wheel landing gear steering mechanical lock or over travel mechanism, depending on the type of nose-wheel steering system, avoid damage to the shock strut internals if the nose-wheel landing gear over travels beyond a specific or predefined nose-wheel landing gear orientation. However, unlocking a locked nose-wheel landing gear steering mechanism consumes considerable time as well as complete investigation and/or airworthiness approval of the nose-wheel landing gear. Moreover, on aircrafts equipped with steering/towing angle orientation markings on the nose-wheel landing gear, the steering/towing angle orientation markings may be overlooked by ground support personnel due to severe weather conditions, i.e. rain, fog, etc., or multiple tasks at hand which may lead to a nose-wheel landing gear over travel incident.

Disclosed herein is a nose landing gear assembly steering feedback system. In various embodiments, the nose landing gear assembly steering feedback system controls the steering operation with real-time feedback of the actual position of the wheel axle into a nose wheel steering control unit (NWSCU). In various embodiments, the nose landing gear assembly steering feedback system includes a static indicator and a rotating sensor. In various embodiments, the static indicator may be aircraft orientation data received from a flight control system (FCS) or a static sensor aligned with aircraft axis and mechanically coupled to at least one of a strut piston or main fitting. In various embodiments, the rotating sensor is mechanically coupled to at least one of a strut piston or wheel axle. In various embodiments, the static sensor and the rotating sensor may be a tilt sensor, a yaw measuring electronic compass (E-Compass) feedback sensor, or a yaw measuring high-accuracy micro electro-mechanical system (MEMS)-based inertial navigation systems (INS) sensors operating via a global navigation satellite system (GNSS) among others. In various embodiments, the static sensor and the rotating sensor each provide an input signal to the NWSCU. In various embodiments, the static sensor and the rotating sensor operate with global compass direction and feed real time angular positions via the input signal to the NWSCU. In various embodiments, the NWSCU determines at least one of a relative angular position, a steering direction, or towing angle of these sensors in relation to one another and implements a corrective action to achieve the intended steering operation and/or provides a display or an alert of at least one of the relative angular position, the steering direction, or the towing angle. In that regard, in various embodiments, the NWSCU may be integrated with a flight control system of the aircraft to process the input signals, store the input signals, determine at least one of a relative angular position, a steering direction, or a towing angle, and/or provide one or more of corrective feedback, alerts, or commands, among others. In various embodiments, the corrective feedback, alerts, or commands, among others, may be via an audio or a visual indication, such as a buzzer, flashing light, or a display, among others. In various embodiments, the NWSCU may provide the corrective feedback, alerts, or commands, among others to personnel, such as ground support personnel, a pilot, air traffic control, among others. In various embodiments, the NWSCU may be programmed with predefined orientation angle limits for the nose landing gear assembly of the particular aircraft in which the NWSCU is installed or for all possible nose landing gear assemblies of all aircraft models. Accordingly, in various embodiments, responsive to the nose landing gear assembly turning more than the predefined orientation angle limits during various operations, such as a towing operation, the NWSCU may provide the corrective feedback, alerts, or commands, among others to personnel in order that appropriate actions may be employed to avoid nose landing gear assembly overtravel incidents and thus, avoiding damages to the nose landing gear assembly as well as other aircraft parts by reducing the human intervention.

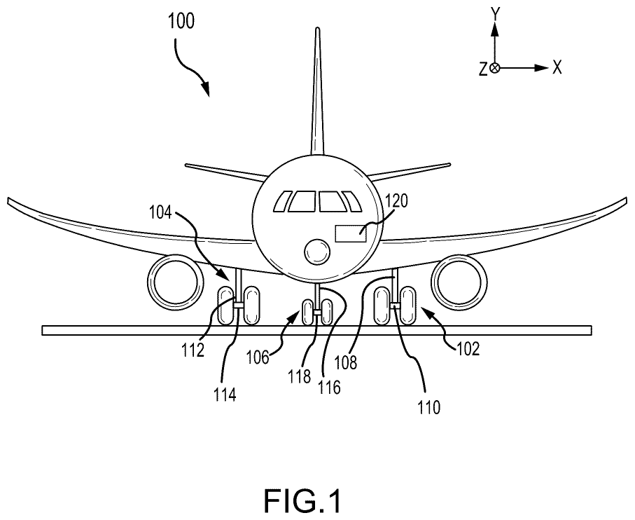

Referring now to FIG. 1, in accordance with various embodiments, an aircraft 100 is illustrated. In various embodiments, aircraft 100 may include one or more landing gear assemblies, such as, for example, a left landing gear assembly 102 (or port-side landing gear assembly), a right landing gear assembly 104 (or starboard-side landing gear assembly) and a nose landing gear assembly 106. Each of left landing gear assembly 102, right landing gear assembly 104, and nose landing gear assembly 106 may support the aircraft 100 when not flying, allowing aircraft 100 to taxi, takeoff, and land safely and without damage to aircraft 100. In various embodiments, left landing gear assembly 102 may include a left shock strut assembly 108 and a left wheel assembly 110, right landing gear assembly 104 may include a right shock strut assembly 112 and a right wheel assembly 114, and nose landing gear assembly 106 may include a nose shock strut assembly 116 and a nose wheel assembly 118. One or more pilot steering input(s) 120 (e.g., steering wheels, pedals, knobs, or the like) may be located in a cockpit of aircraft 100.

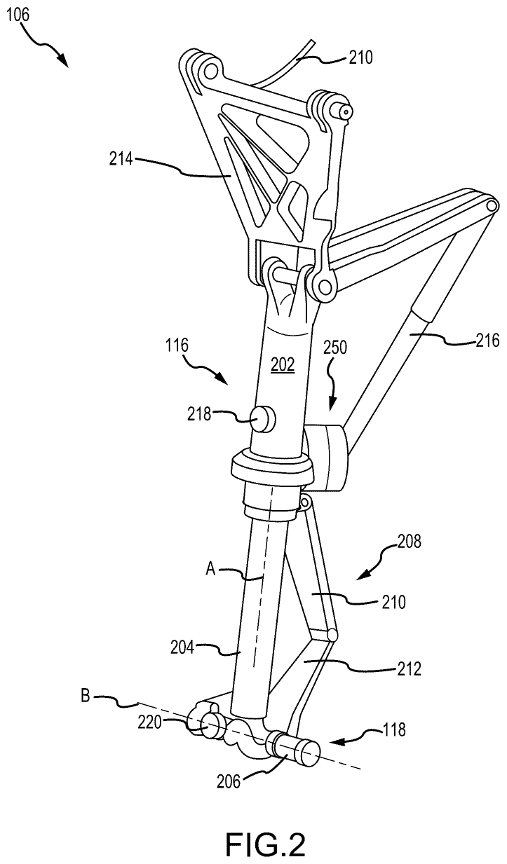

Referring now to FIG. 2, in accordance with various embodiments, nose landing gear assembly 106 is illustrated. In various embodiments, the nose shock strut assembly 116 of nose landing gear assembly 106 includes a strut cylinder 202 and a strut piston 204. Strut piston 204 may be operatively coupled to strut cylinder 202. Strut cylinder 202 may be configured to receive strut piston 204 in a manner that allows the two components to telescope with respect to one another. Strut piston 204 may translate into and out the strut cylinder 202, thereby absorbing and damping loads imposed on nose landing gear assembly 106. An axle 206 of nose wheel assembly 118 may be coupled to an end of strut piston 204 that is opposite strut cylinder 202.

The nose wheels have been removed from nose wheel assembly 118 in FIG. 2 to more clearly illustrate the features of the nose shock strut assembly 116.

In various embodiments, nose landing gear assembly 106 may include a torque link 208 coupled to the nose shock strut assembly 116 and/or to axle 206. Torque link 208 may include a first (or upper) arm 210 and a second (or lower) arm 212. First arm 210 is pivotably coupled to second arm 212. Strut cylinder 202 is coupled to an attachment linkage 214 configured to secure the nose shock strut assembly 116 to the aircraft 100 and to translate nose landing gear assembly 106 between the landing gear up and landing gear down positions. Nose landing gear assembly 106 may include one or more drag brace(s) such as drag brace 216. In various embodiments, drag brace 216 may be located proximate an aft side of the nose shock strut assembly 116. Nose landing gear assembly 106 may include one or more hydraulic fluid lines (i.e. conduits).

In various embodiments, nose landing gear assembly 106 includes a hydraulic motor 250. Hydraulic motor 250 is operably coupled to strut cylinder 202 via the nose shock strut assembly 116. In this regard, and as described in further detail below, hydraulic motor 250 is configured to rotate strut piston 204 about a piston axis of rotation A (also reference to as “axis A”), thereby adjusting the orientation of the nose wheel assembly 118 and the taxiing direction of the aircraft 100. Axis of rotation A may be parallel to the direction of translation of strut piston 204 relative to strut cylinder 202.

In order to implement the nose landing gear assembly steering feedback system, in various embodiments, a static sensor 218 may be aligned with axis A, i.e. strut cylinder 202 or a main fitting, and mechanically coupled to the nose shock strut assembly 116. Further, in order to implement the nose landing gear assembly steering feedback system, in various embodiments, a rotating sensor 220 may be mechanically coupled to at least one of the strut piston 216 or an axle 206, and also be aligned with axis A as well as a wheel axis of rotation B (also reference to as “axis B”) through the axle 206 of nose wheel assembly 118, such that rotating sensor 220 rotates with nose wheel assembly 118.

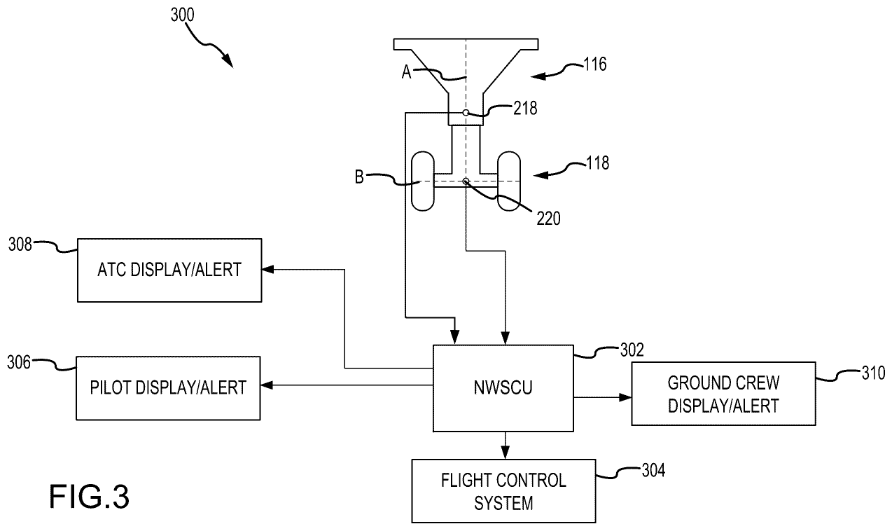

Referring now to FIG. 3, in accordance with various embodiments, nose landing gear assembly steering feedback system 300 integrated in an aircraft, such as aircraft 100 of FIG. 1, is illustrated. In various embodiments, the nose landing gear assembly steering feedback system 300 includes a nose wheel steering control unit (NWSCU) 302, a static sensor, such as the statice sensor 218 of FIG. 2, and a rotating sensor, such as rotating sensor 220 of FIG. 2. In various embodiments, the NWSCU 302 may include a logic device such as one or more of a central processing unit (CPU), an accelerated processing unit (APU), a digital signal processor (DSP), a field programmable gate array (FPGA), an application specific integrated circuit (ASIC), or the like. In various embodiments, the NWSCU 302 may further include any non-transitory memory known in the art. The memory may store instructions usable by the logic device to perform operations as described herein as well as store information determined by the NWSCU 302.

In various embodiments, the NWSCU 302 may be coupled to the static sensor 218 and the rotating sensor 220 via a wired or a wireless communication connection. In various embodiments, the wireless communication connection may be wireless avionic intra communication (WAIC). As discussed with reference to FIG. 2, in various embodiments, the static sensor 218 may be aligned with axis A and mechanically coupled to the nose shock strut assembly 116. In various embodiments, the rotating sensor 220 may be mechanically coupled to a center of a nose wheel assembly 118, aligned with axis A, aligned with a wheel axis of rotation B (also reference to as “axis B”) through the axle 206 of nose wheel assembly 118, and rotate with the nose wheel assembly 118. In various embodiments, the static sensor 218 and the rotating sensor 220 may be a tilt sensor, a yaw-measuring electronic compass (E-Compass) feedback sensor, or a yaw measuring high-accuracy micro electro-mechanical system (MEMS)-based inertial navigation systems (INS) sensors operating via a global navigation satellite system (GNSS), among others. In various embodiments, the static sensor 218 and the rotating sensor 220 each provide an input signal to the NWSCU 302. In various embodiments, the static sensor 218 and the rotating sensor 220 operate with global compass direction and feed real time angular positions via the input signal to the NWSCU 302.

In various embodiments, the NWSCU 302 utilizes the real time angular position from each the rotating sensor 220 and either a flight control system 304 or the static sensor 218 to determine at least one of a relative angular position, a steering direction, or a towing angle of the static sensor 218 and the rotating sensor 220 in relation to one another. For example, in various embodiments, the NWSCU 302 may receive a first input signal from the static sensor 218 indicating a global compass direction of 45° and may receive a second input signal from the rotating sensor 220 indicating a global compass direction as 60°. Accordingly, in various embodiments, the NWSCU 302 may determine at least one of the relative angular position, the steering direction, or the towing angle of 15° with regard to a centerline axis of the aircraft. In various embodiments, the NWSCU 302 may be integrated with or communicatively coupled to a flight control system 304 of the aircraft 100. In various embodiments, responsive to the at least one of the relative angular position, the steering direction, or the towing angle being different than that commanded by a pilot via the flight control system 304 or the ground crew 310, then flight control system 304 may implement a corrective action to correct the relative angular position, the steering direction, or the towing angle.

In various embodiments, the NWSCU 302 may be communicatively coupled to at least one of a pilot display and/or alert system 306, an air traffic control display and/or alert system 308, or a ground crew display and/or alert system 310. In various embodiments, the NWSCU 302 may transmit at least of the determined relative angular position, steering direction, or towing angle to the pilot display and/or alert system 306, the air traffic control display and/or alert system 308, or the ground crew display and/or alert system 310 in order to make the pilot, air traffic control, and/or the ground crew aware of at least one of the relative angular position, the steering direction, or the towing angle of the aircraft 100. In various embodiments, if the transmission is an alert, the alert may be an audio or a visual indication, such as a buzzer or a flashing light. In various embodiments, the NWSCU 302 may further include a memory to store all determined relative angular positions, steering directions, or towing angles as a digital record for later maintenance of one or more of towing, steering, or taxiing operations.

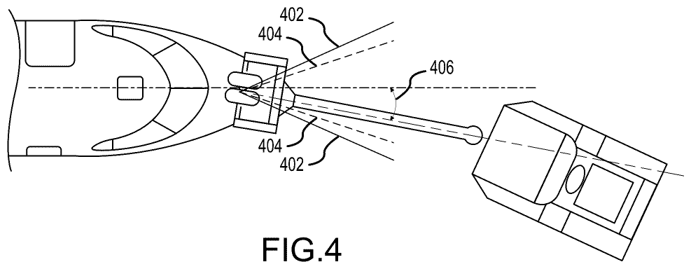

With further reference to FIG. 4 that, in accordance with various embodiments, illustrates predefined orientation angle limits for the nose landing gear assembly. In various embodiments, the NWSCU 302 may be programmed with predefined orientation angle limits 402 as well as approaching predefined orientation angle limits 404 for the nose landing gear assembly 106 of the aircraft 100. In various embodiments, the NWSCU 302 may be programmed with predefined orientation angle limits 402 as well as approaching predefined orientation angle limits 404 for the nose landing gear assembly of particular aircraft in which the NWSCU 302 is installed or for all possible nose landing gear assemblies for all aircrafts models. Accordingly, in various embodiments, responsive to the nose landing gear assembly turning angle 406 being between the approaching predefined orientation angle limits 404 and the predefined orientation angle limits 402, such as under a towing operation, the NWSCU 302 may provide the corrective feedback, alerts, or a corrective command, among others, to the pilot display and/or alert system 306, the air traffic control display and/or alert system 308, or the ground crew display and/or alert system 310 in order to make the pilot, air traffic control, and/or the ground crew aware in order that appropriate actions may be employed to avoid nose landing gear assembly overtravel incidents and thus, avoiding damages to the nose landing gear assembly as well as other aircraft parts by reducing the human intervention.

Accordingly, in various embodiments, the nose landing gear assembly steering feedback system may provide a smart alternative feedback in place of existing mechanical or electro-mechanical system. In various embodiments, the nose landing gear assembly steering feedback system may provide a centralized alert system to pilots, air traffic control, and/or ground crew. In various embodiments, the nose landing gear assembly steering feedback system may provide a digital record of all determined relative angular positions, steering directions, or towing angles for later maintenance of one or more of towing, steering, or taxiing operations.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Numbers, percentages, or other values stated herein are intended to include that value, and also other values that are about or approximately equal to the stated value, as would be appreciated by one of ordinary skill in the art encompassed by various embodiments of the present disclosure. A stated value should therefore be interpreted broadly enough to encompass values that are at least close enough to the stated value to perform a desired function or achieve a desired result. The stated values include at least the variation to be expected in a suitable industrial process, and may include values that are within 10%, within 5%, within 1%, within 0.1%, or within 0.01% of a stated value. Additionally, the terms “substantially,” “about” or “approximately” as used herein represent an amount close to the stated amount that still performs a desired function or achieves a desired result. For example, the term “substantially,” “about” or “approximately” may refer to an amount that is within 10% of, within 5% of, within 1% of, within 0.1% of, and within 0.01% of a stated amount or value.

Furthermore, no element, component, or method step in the present disclosure is intended to be dedicated to the public regardless of whether the element, component, or method step is explicitly recited in the claims. No claim element herein is intended to invoke 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above-described concepts can be used alone or in combination with any or all of the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. A nose landing gear assembly steering feedback system, the nose landing gear assembly steering feedback system comprising:
a static indicator;
a rotating sensor;
a nose wheel steering control unit, the static indicator and the rotating sensor communicatively coupled to the nose wheel steering control unit, wherein the nose wheel steering control unit is configured to:
responsive to receiving a first input signal from the static indicator and a second input signal from the rotating sensor, determine at least one of a relative angular position, a steering direction, or a towing angle; and
provide an indication of at least one of the relative angular position, the steering direction, or the towing angle to at least one of a pilot, air traffic control, or a ground crew.

2. The nose landing gear assembly steering feedback system of claim 1, wherein the static indicator is at least one of aircraft orientation data received from a flight control system or a static sensor.

3. The nose landing gear assembly steering feedback system of claim 2, wherein the static sensor is mechanically coupled to a nose shock strut assembly of a nose landing gear assembly, wherein the static sensor is at least one of a tilt sensor, a yaw-measuring electronic compass (E-Compass) feedback sensor, or a yaw measuring high-accuracy micro electro-mechanical system (MEMS)-based inertial navigation systems (INS) sensors operating via a global navigation satellite system (GNSS), and wherein the static sensor is aligned with an axis of rotation of at least one of a strut cylinder or main fitting of the nose landing gear assembly.

4. The nose landing gear assembly steering feedback system of claim 1, wherein the rotating sensor is mechanically coupled to a nose wheel assembly of a nose landing gear assembly and wherein the rotating sensor is at least one of a tilt sensor, a yaw-measuring electronic compass (E-Compass) feedback sensor, or a yaw measuring high-accuracy micro electro-mechanical system (MEMS)-based inertial navigation systems (INS) sensors operating via a global navigation satellite system (GNSS).

5. The nose landing gear assembly steering feedback system of claim 4, wherein the rotating sensor is aligned with an axis of rotation of a strut piston of the nose landing gear assembly and an axis of rotation of a wheel of the nose landing gear assembly.

6. The nose landing gear assembly steering feedback system of claim 1, wherein the nose wheel steering control unit is further configured to:
provide the indication of at least one of the relative angular position, the steering direction, or the towing angle to a flight control system of an aircraft; and
responsive to the at least one of the relative angular position, the steering direction, or the towing angle being different than a commanded relative angular position, a commanded steering direction, or a commanded towing angle, cause a corrective action to correct at least one of the relative angular position, the steering direction, or the towing angle to match at least one of the commanded relative angular position, the commanded steering direction, or the commanded towing angle.

7. The nose landing gear assembly steering feedback system of claim 1, wherein the indication of at least one of the relative angular position, the steering direction, or the towing angle to at least one of the pilot, the air traffic control, or the ground crew is displayed on a display of at least one of the pilot, the air traffic control, or the ground crew.

8. The nose landing gear assembly steering feedback system of claim 1, wherein the indication of at least one of the relative angular position, the steering direction, or the towing angle to at least one of the pilot, the air traffic control, or the ground crew is an alert, wherein the alert is at least one of an audio alert or a visual alert.

9. The nose landing gear assembly steering feedback system of claim 1, wherein the nose wheel steering control unit is further configured with predefined orientation angle limits for a nose landing gear assembly and wherein the nose wheel steering control unit is further configured to:
responsive to at least one of the relative angular position, the steering direction, or the towing angle meeting one predefined orientation angle limit of the predefined orientation angle limits, provide at least one of a corrective feedback, an alert, or a corrective command to at least one of the pilot, the air traffic control, or the ground crew indicating that the one predefined orientation angle limit has been met.

10. The nose landing gear assembly steering feedback system of claim 9, wherein the nose wheel steering control unit is further configured with approaching predefined orientation angle limits for the nose landing gear assembly and wherein the nose wheel steering control unit is further configured to:
responsive to at least one of the relative angular position, the steering direction, or the towing angle being between one predefined orientation angle limit of the predefined orientation angle limits and one approaching predefined orientation angle limit of the approaching predefined orientation angle limits, provide at least one of the corrective feedback, the alert, or the corrective command to at least one of the pilot, the air traffic control, or the ground crew.

11. An aircraft, the aircraft comprising:
a nose landing gear assembly; and
a nose landing gear assembly steering feedback system, the nose landing gear assembly steering feedback system comprising:
a static indicator;
a rotating sensor;
a nose wheel steering control unit, the static indicator and the rotating sensor communicatively coupled to the nose wheel steering control unit, wherein the nose wheel steering control unit is configured to:
responsive to receiving a first input signal from the static indicator and a second input signal from the rotating sensor, determine at least one of a relative angular position, a steering direction, or a towing angle; and
provide an indication of at least one of the relative angular position, the steering direction, or the towing angle to at least one of a pilot, air traffic control, or a ground crew.

12. The aircraft of claim 11, wherein the static indicator is at least one of aircraft orientation data received from a flight control system or a static sensor.

13. The aircraft of claim 12, wherein the static sensor is mechanically coupled to a nose shock strut assembly of the nose landing gear assembly, wherein the static sensor is at least one of a tilt sensor, a yaw-measuring electronic compass (E-Compass) feedback sensor, or a yaw measuring high-accuracy micro electro-mechanical system (MEMS)-based inertial navigation systems (INS) sensors operating via a global navigation satellite system (GNSS), and wherein the static sensor is aligned with an axis of rotation of at least one of a strut cylinder or main fitting of the nose landing gear assembly.

14. The aircraft of claim 11, wherein the rotating sensor is mechanically coupled to a nose wheel assembly of the nose landing gear assembly and wherein the rotating sensor is at least one of a tilt sensor, a yaw-measuring electronic compass (E-Compass) feedback sensor, or a yaw measuring high-accuracy micro electro-mechanical system (MEMS)-based inertial navigation systems (INS) sensors operating via a global navigation satellite system (GNSS).

15. The aircraft of claim 14, wherein the rotating sensor is aligned with an axis of rotation of a strut piston of the nose landing gear assembly and an axis of rotation of a wheel of the nose landing gear assembly.

16. The aircraft of claim 11, wherein the nose wheel steering control unit is further configured to:
provide the indication of at least one of the relative angular position, the steering direction, or the towing angle to a flight control system of the aircraft; and
responsive to the at least one of the relative angular position, the steering direction, or the towing angle being different than a commanded relative angular position, a commanded steering direction, or a commanded towing angle, cause a corrective action to correct at least one of the relative angular position, the steering direction, or the towing angle to match at least one of the commanded relative angular position, the commanded steering direction, or the commanded towing angle.

17. The aircraft of claim 11, wherein the indication of at least one of the relative angular position, the steering direction, or the towing angle to at least one of the pilot, the air traffic control, or the ground crew is displayed on a display of at least one of the pilot, the air traffic control, or the ground crew.

18. The aircraft of claim 11, wherein the indication of at least one of the relative angular position, the steering direction, or the towing angle to at least one of the pilot, the air traffic control, or the ground crew is an alert, wherein the alert is at least one of an audio alert or a visual alert.

19. The aircraft of claim 11, wherein the nose wheel steering control unit is further configured with predefined orientation angle limits for the nose landing gear assembly and wherein the nose wheel steering control unit is further configured to:
responsive to at least one of the relative angular position, the steering direction, or the towing angle meeting one predefined orientation angle limit of the predefined orientation angle limits, providing at least one of a corrective feedback, an alert, or a corrective command to at least one of the pilot, the air traffic control, or the ground crew indicating that the one predefined orientation angle limit has been met.

20. The aircraft of claim 19, wherein the nose wheel steering control unit is further configured with approaching predefined orientation angle limits for the nose landing gear assembly and wherein the nose wheel steering control unit is further configured to:
responsive to at least one of the relative angular position, the steering direction, or the towing angle being between one predefined orientation angle limit of the predefined orientation angle limits and one approaching predefined orientation angle limit of the approaching predefined orientation angle limits, providing at least one of the corrective feedback, the alert, or the corrective command to at least one of the pilot, the air traffic control, or the ground crew.
